(19) United States
(12) Patent Application Publication
(10) Pub. No.: US 2005/0288408 A1
(43) Pub. Date: Dec. 29, 2005

(54) Silica reinforced elastomer compounds prepared with dry liquid modifiers

(76) Inventors: Rui Resendes, Corunna (CA); Shayna Odegaard, Edinburgh (GB); Herman-Josef Weidenhaupt, Pulheim (DE); Philip Brain, Sarnia (CA)

Correspondence Address: LANXESS CORPORATION, 111 RIDC PARK WEST DRIVE, PITTSBURGH, PA, 15275-1112, US

(21) Appl. No.: 10/875,377

(22) Filed: Jun. 24, 2004

(30) Foreign Application Priority Data
Jun. 23, 2004 (CA) 2,471,006

(51) Int. Cl. C08K 5/24; C08K 3/34

(52) U.S. Cl. 524/261; 524/492; 524/445

(57) ABSTRACT

The present invention provides a process for preparing a filled halobutyl elastomer, which includes mixing a halobutyl elastomer with at least one mineral filler and at least one dry liquid modifier and optionally curing the filled elastomer with sulfur or other curative systems. Filled halobutyl elastomers prepared according to the present invention possess improved levels of filler dispersion which results in a reduction in the hardness of the compound and an increased tensile strength.

### FIELD OF THE INVENTION

The present invention relates to a silica-filled halogenated butyl elastomers, such as bromobutyl elastomers (BIIR), prepared, in part, with dry liquid modifiers. The present invention also relates to a process to prepare silica-filled halogenated butyl elastomers and products produced therefrom.

### BACKGROUND OF THE INVENTION

It is known that reinforcing fillers such as carbon black and silica greatly improve the strength and fatigue properties of elastomeric compounds. It is also known that chemical interactions occur between the elastomer and the filler. Good interaction between carbon black and highly unsaturated elastomers such as polybutadiene (BR) and styrene butadiene copolymers (SBR) occurs due to the large number of carbon-carbon double bonds present in the copolymers. Butyl elastomers may have only one tenth, or fewer, of the carbon-carbon double bonds found in BR or SBR, and compounds made from butyl elastomers are known to interact poorly with carbon black. For example, a compound prepared by mixing carbon black with a combination of BR and butyl elastomers results in domains of BR, which contain most of the carbon black, and butyl domains which contain very little carbon black. It is also known that butyl compounds have poor abrasion resistance.

Canadian Patent Application 2,293,149 teaches that it is possible to produce filled butyl elastomer compositions with improved physical properties by combining halobutyl elastomers with silica and specific silanes. These silanes act as dispersing and bonding agents between the halogenated butyl elastomer and the filler. However, one disadvantage of the use of silanes is the evolution of alcohol during the manufacturing process and potentially during the use of the manufactured article produced by this process. Additionally, silanes significantly increase the cost of the resulting manufactured article.

Co-pending Canadian Patent Application 2,418,822 teaches a process for preparing compositions containing halobutyl elastomers and at least one mineral filler that has been reacted with at least one organic compound containing at least one basic nitrogen-containing group and at least one hydroxyl group and optionally at least one silazane compound before admixing the (pre-reacted) filler with the halobutyl elastomer. According to CA 2,418,822 the elastomers have improved properties, such as tensile strength and abrasion resistance due to the pre-functionalization of the silica with DMAE and/or HMDZ.

Co-pending Canadian Application CA 2,368,363 (U.S. Pat. No. 6,706,804) discloses filled halobutyl elastomer compositions containing halobutyl elastomers, at least one mineral filler in the presence of organic compounds containing at least one basic amine group and at least one hydroxyl group and at least one silazane compound.

Co-pending Canadian Patent Application 2,339,080 discloses filled halobutyl elastomeric compounds containing certain organic compounds containing at least one basic nitrogen-containing group and at least one hydroxyl group enhance the interaction of halobutyl elastomers with carbon-black and mineral fillers, resulting in improved compound properties such as tensile strength and abrasion (DIN).

It is known in the art to immobilize conventional modifiers such as, TESPD or TESPT onto carbon black or to impregnate such conventional modifiers into waxes. U.S. Pat. No. 5,159,009 discloses carbon black modified with organisilicon compounds and a method for producing the modified carbon black and their use in rubber mixtures. The handling requirements of modifiers in this form are less complicated than those of their counterpart in neat liquid form. X 50-S is such a commercially available product from Degussa and is a blend of the bifunctional, sulfur containing organosilane Si 69® [Bis(triethoxysilylpropyl)polysulfide] and an N 330 type carbon black in a blend ratio of 1:1.

U.S. Pat. No. 5,494,955 discloses the use of silane coupling agents with carbon black to enhance the balance of reinforcement properties of rubber compounds. According to U.S. Pat. No. 5,494,955 useful rubber compounds can be generated by treating a rubber compound and the carbon black with Si69 at Banbury mixing temperatures, the Si69 (or Degussa X 50-S) is not applied as a pretreating as disclosed in U.S. Pat. No. 5,159,009 but rather added “in situ” to the Banbury mixer with the carbon black.

Filled halobutyl elastomeric compounds according to the present invention utilize dry liquids, such as dry liquid forms of DMEA and HMDZ as a novel class of modifiers. Unlike the silane modifiers known in the cited art, the dry liquid modifiers according to the present invention are less volatile and therefore safer to use. In addition, the use of the dry liquid modifiers according to the present invention does not result in the evolution of alcohols during the mixing process. In contrast, the use of silane modifiers as known in the cited art, results in the evolution of alcohols during compound mixing and curing. Furthermore, the use of the dry liquid modifier described in this invention represents a significant cost savings as these materials are significantly less expensive than traditional silanes.

### SUMMARY OF THE INVENTION

The present invention provides a silica reinforced elastomer compound containing halobutyl elastomers, at least one mineral filler and a one dry liquid modifier.

Surprisingly, it has been discovered that it is possible to realize the level of reinforcement in butyl compounds modified with a mixture of a silazane compound and/or an additive which posses at least one amine group and at least one hydroxyl group and in butyl compounds modified with dry liquid forms of a silazine compound and/or an additive which possesses at least one amine group and at least one hydroxyl group.

Accordingly, the present invention also provides a process which includes mixing a halobutyl elastomer with at least one mineral filler, and at least one dry liquid modifier, and then curing the resulting filled halobutyl elastomer. According to the present invention, the resulting filled halobutyl elastomer has improved properties.

### BRIEF DESCRIPTION OF THE DRAWINGS

The FIGURE illustrates the dynamic properties of a BIIR-based tread formulation prepared with dry liquid modifiers.

### DETAILED DESCRIPTION OF THE INVENTION

The phrase “halobutyl elastomer(s)” as used herein refers to a chlorinated and/or brominated butyl elastomer. Brominated butyl elastomers are preferred, and the present invention is illustrated, by way of example, with reference to such bromobutyl elastomers. It should be understood, however, that the present invention includes use of chlorinated butyl elastomers.

Brominated butyl elastomers may be obtained by bromination of butyl rubber (which is a copolymer of an isoolefin, usually isobutylene and a co-monomer that is usually a C₄ to C₆ conjugated diolefin, preferably isoprene—(brominated isobutene-isoprene-copolymers BIIR)). Co-monomers other than conjugated diolefins can be used, for example, alkyl-substituted vinyl aromatic co-monomers such as C₁-C₄-alkyl substituted styrene(s). An example of such an elastomer which is commercially available is brominated isobutylene methylstyrene copolymer (BIMS) in which the co-monomer is p-methylstyrene.

Brominated butyl elastomers typically contain in the range of from 0.1 to 10 weight percent of repeating units derived from diolefin (preferably isoprene) and in the range of from 90 to 99.9 weight percent of repeating units derived from isoolefin (preferably isobutylene) (based upon the hydrocarbon content of the polymer) and in the range of from 0.1 to 9 weight percent bromine (based upon the bromobutyl polymer). A typical bromobutyl polymer has a molecular weight, expressed as the Mooney viscosity according to DIN 53 523 (ML 1+8 at 125° C.), in the range of from 25 to 60.

According to the present invention, the brominated butyl elastomer preferably contains in the range of from 0.5 to 5 weight percent of repeating units derived from isoprene (based upon the hydrocarbon content of the polymer) and in the range of from 95 to 99.5 weight percent of repeating units derived from isobutylene (based upon the hydrocarbon content of the polymer) and in the range of from 0.2 to 3 weight percent, preferably from 0.75 to 2.3 weight percent, of bromine (based upon the brominated butyl polymer).

A stabilizer may be added to the brominated butyl elastomer. Suitable stabilizers include calcium stearate and hindered phenols, preferably used in an amount in the range of from 0.5 to 5 parts per 100 parts by weight of the brominated butyl rubber (phr).

Examples of suitable brominated butyl elastomers include Bayer Bromobutyl® 2030, Bayer Bromobutyl® 2040 (BB2040), and Bayer Bromobutyl® X2 commercially available from Bayer. Bayer BB2040 has a Mooney viscosity (ML 1+8 @ 125° C.) of 39±4, a bromine content of 2.0±0.3 wt % and an approximate weight average molecular weight of 500,000 grams per mole.

The brominated butyl elastomer used in the process of the present invention may also be a graft copolymer of a brominated butyl rubber and a polymer based upon a conjugated diolefin monomer. Co-pending Canadian Patent Application 2,279,085 is directed towards a process for preparing graft copolymers by mixing solid brominated butyl rubber with a solid polymer based on a conjugated diolefin monomer which also includes some C—S—(S)ₙ—C bonds, where n is an integer from 1 to 7, the mixing being carried out at a temperature greater than 50° C. and for a time sufficient to cause grafting. The disclosure of this application is incorporated herein by reference with regard to jurisdictions allowing for this procedure.

The bromobutyl elastomer of the graft copolymer can be any of those described above. The conjugated diolefins that can be incorporated in the graft copolymer generally have the structural formula: 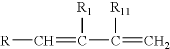
wherein R is a hydrogen atom or an alkyl group containing from 1 to 8 carbon atoms and wherein R₁ and R₁₁ can be the same or different and are selected from hydrogen atoms and alkyl groups containing from 1 to 4 carbon atoms. Non-limiting examples of suitable conjugated diolefins include 1,3-butadiene, isoprene, 2-methyl-1,3-pentadiene, 4-butyl-1,3-pentadiene, 2,3-dimethyl-1,3-pentadiene 1,3-hexadiene, 1,3-octadiene, 2,3-dibutyl-1,3-pentadiene, 2-ethyl-1,3-pentadiene, 2-ethyl-1,3-butadiene and the like. Conjugated diolefin monomers containing from 4 to 8 carbon atoms are preferred, 1,3-butadiene and isoprene are more preferred.

The polymer based on a conjugated diene monomer can be a homopolymer, or a copolymer of two or more conjugated diene monomers, or a copolymer with a vinyl aromatic monomer.

The vinyl aromatic monomers which can optionally be used are selected so as to be copolymerizable with the conjugated diolefin monomers being employed. Generally, any vinyl aromatic monomer which is known to polymerize with organo-alkali metal initiators can be used.

Suitable vinyl aromatic monomers usually contain in the range of from 8 to 20 carbon atoms, preferably from 8 to 14 carbon atoms. Examples of vinyl aromatic monomers which can be copolymerized include styrene, alpha-methyl styrene, and various alkyl styrenes including p-methylstyrene, p-methoxy styrene, 1-vinylnaphthalene, 2-vinyl naphthalene, 4-vinyl toluene and the like. Styrene is preferred for copolymerization with 1,3-butadiene alone or for terpolymerization with both 1,3-butadiene and isoprene.

The halogenated butyl elastomer may be used alone or in combination with other elastomers such as:
BR—polybutadiene
ABR—butadiene/C₁-C₄ alkyl acrylate copolymers
CR—polychloroprene
IR—polyisoprene
SBR—styrene/butadiene copolymers with styrene contents of 1 to 60, preferably 20 to 50 wt. %
IIR—isobutylene/isoprene copolymers
NBR—butadiene/acrylonitrile copolymers with acrylonitrile contents of 5 to 60, preferably 10 to 40 wt. %
HNBR—partially hydrogenated or completely hydrogenated NBR
EPDM—ethylene/propylene/diene copolymers

The filler is composed of particles of a mineral, and examples include silica, silicates, clay (such as bentonite), gypsum, alumina, titanium dioxide, talc and the like, as well as mixtures thereof.

Further examples include:
highly dispersible silicas, prepared e.g. by the precipitation of silicate solutions or the flame hydrolysis of silicon halides, with specific surface areas of 5 to 1000, preferably 20 to 400 m²/g (BET specific surface area), and with primary particle sizes of 10 to 400 nm; the silicas can optionally also be present as mixed oxides with other metal oxides such as those of Al, Mg, Ca, Ba, Zn, Zr and Ti;
synthetic silicates, such as aluminum silicate and alkaline earth metal silicates;
magnesium silicate or calcium silicate, with BET specific surface areas of 20 to 400 m²/g and primary particle diameters of 10 to 400 nm;
natural silicates, such as kaolin and other naturally occurring silica;
glass fibers and glass fiber products (matting, extrudates) or glass microspheres;
unmodified and organophilically modified clays, including natural occurring and synthetic clays, such as montmorillonite clay;
metal oxides, such as zinc oxide, calcium oxide, magnesium oxide and aluminum oxide;
metal carbonates, such as magnesium carbonate, calcium carbonate and zinc carbonate;
metal hydroxides, e.g. aluminum hydroxide and magnesium hydroxide; or combinations thereof.

Some mineral particles have hydroxyl groups on their surface, rendering them hydrophilic and oleophobic. This exacerbates the difficulty of achieving good interaction between the filler particles and the butyl elastomer. For many purposes, the preferred mineral is silica, preferably silica prepared by the carbon dioxide precipitation of sodium silicate.

Dried amorphous silica particles suitable for use in accordance with the present invention have a mean agglomerate particle size in the range of from 1 to 100 microns, preferably between 10 and 50 microns and more preferably between 10 and 25 microns. It is preferred that less than 10 percent by volume of the agglomerate particles are below 5 microns or over 50 microns in size. A suitable amorphous dried silica moreover has a BET surface area, measured in accordance with DIN (Deutsche Industrie Norm) 66131, of between 50 and 450 square meters per gram and a DBP absorption, as measured in accordance with DIN 53601, of between 150 and 400 grams per 100 grams of silica, and a drying loss, as measured according to DIN ISO 787/11, of from 0 to 10 percent by weight. Suitable silica fillers are available under the trademarks HiSil® 210, HiSil® 233 and HiSil® 243 from PPG Industries Inc. Also suitable are Vulkasil S and Vulkasil N, from Bayer AG (Vulkasil is a registered trademark of Bayer AG).

Those mineral fillers may be used in combination with known non-mineral fillers, such as
carbon blacks; the carbon blacks to be used here are prepared by the lamp black, furnace black or gas black process and have BET specific surface areas of 20 to 200 m²/g, e.g. SAF, ISAF, HAF, FEF or GPF carbon blacks; or
rubber gels, preferably those based on polybutadiene, butadiene/styrene copolymers, butadiene/acrylonitrile copolymers and polychloroprene.

The amount of filler to be incorporated into the halobutyl elastomer can vary between wide limits. Typical amounts of the filler range from 20 parts to 250 parts, preferably from 30 parts to 100 parts, more preferably from 40 to 80 parts per hundred parts of elastomer.

Non-mineral fillers are not normally used as filler in the halobutyl elastomer compositions of the present invention, however, non-mineral fillers may be present in an amount up to 40 phr. In these cases, it is preferred that the mineral filler should constitute at least 55% by weight of the total amount of filler. If the halobutyl elastomer composition of the present invention is blended with another elastomeric composition, that other composition may contain mineral and/or non-mineral fillers.

The rubber compound according to the present invention is prepared in the presence of a liquid modifier, such as DMAE or HMDZ applied to a support, such as carbon black. Accordingly, the rubber compound according to the present invention is prepared in the presence of a dry liquid form of an organic compound containing at least one basic nitrogen-containing group and at least one hydroxyl group. Examples include proteins, aspartic acid, 6-aminocaproic acid, and other compounds comprising an amino and an alcohol function, such as diethanolamine and triethanolamine. Preferably, the organic compound containing at least one basic nitrogen-containing group and at least one hydroxyl group comprises a primary alcohol group and an amine group separated by methylene bridges, the methylene bridges may be branched. Such compounds have the general formula HO-A-NH₂; wherein A represents a C₁ to C₂₀ alkylene group, which may be linear or branched.

More preferably, the number of methylene groups between the two functional groups should be in the range of from 1 to 4. Examples of preferred additives include monoethanolamine and N,N-dimethyamino-ethanol (DMAE).

The rubber compound according to the present invention can also be prepared in the presence of a silazane compound having one or more silazane groups, such as a disilazane in a dry liquid form. Organic silazane compounds are preferred. Examples include but are not limited to Hexamethyldisilazane (HDMZ), Heptamethyldisilazane, 1,1,3,3-Tetramethyldisilazane, 1,3-bis(Chloromethyl)tetramethyldisilazane, 1,3-Divinyl-1,1,3,3-tetramethyldisilazane, and 1,3-Diphenyltetramethyl-disilazane.

In accordance with the present invention the liquid forms of the modifiers are applied to a support. Examples of suitable supports include silicates, precipitated silicas, clays, carbon black, talc or polymers. In general, mixtures containing 5 to 55 wt. % support are used. More preferably from 10 to 50 wt. %. Even more preferably from 15 to 45 wt. %. Suitable carbon black or silica supports include those described and disclosed above.

The amount of dry liquid modifier to be incorporated into the halobutyl elastomer can vary. Preferably from 0.5 parts to 15 parts, more preferably from 1 part to 10 parts, most preferably from 5 to 10 parts per hundred parts of elastomer.

According to the present invention the liquid modifier can be applied to a support by any known method, preferably mechanical methods. More preferably, the liquid modifier and support are added to a closed vessel containing ball bearings and agitated for a period of time sufficient to produce a homogeneous mixture.

According to the present invention, the dry liquid modifier can be reacted with the mineral filler prior to admixing with the halobutyl elastomer. The process for preparing such pre-reacted fillers is disclosed in Co-pending Canadian Patent Application 2,418,822, and for jurisdictions allowing such, the teachings of CA 2,418,822 are incorporated by reference.

Furthermore up to 40 parts of processing oil, preferably from 5 to 20 parts, per hundred parts of elastomer, may be present in the elastomeric compound. Further, a lubricant, for example a fatty acid such as stearic acid, may be present in an amount up to 3 parts, more preferably in an amount up to 2 parts per hundred parts of elastomer.

The halobutyl elastomer that is admixed with the mineral filler and the dry liquid modifier may be in a mixture with another elastomer or elastomeric compound. The halobutyl elastomer should constitute more than 5% of any such mixture. Preferably the halobutyl elastomer should constitute at least 10% of any such mixture. More preferably the halobutyl elastomer constitutes at least 50% of any such mixture. In most cases it is preferred not to use mixtures but to use the halobutyl elastomer as the sole elastomer. If mixtures are to be used, however, then the other elastomer may be, for example, natural rubber, polybutadiene, styrene-butadiene or poly-chloroprene or an elastomer compound containing one or more of these elastomers.

The filled halobutyl elastomer can be cured to obtain a product which has improved properties, for instance in abrasion resistance and tensile strength. Curing can be effected with sulfur. The preferred amount of sulfur is in the range of from 0.3 to 2.0 parts per hundred parts of rubber. An activator, for example zinc oxide, may also be used, in an amount in the range of from 0.5 parts to 2 parts per hundred parts of rubber. Other ingredients, for instance stearic acid, antioxidants, or accelerators may also be added to the elastomer prior to curing. Sulphur curing is then effected in the known manner. See, for instance, chapter 2, “The Compounding and Vulcanization of Rubber”, of “Rubber Technology”, 3^{rd} edition, published by Chapman & Hall, 1995, the disclosure of which is incorporated by reference with regard to jurisdictions allowing for this procedure.

Other curatives known to cure halobutyl elastomers may also be used. A number of compounds are known to cure halobutyl elastomers, for example, bis dieneophiles (for example m-phenyl-bis-maleamide, HVA2), phenolic resins, amines, amino-acids, peroxides, zinc oxide and the like. Combinations of the aforementioned curatives may also be used. The mineral-filled halobutyl elastomer of the present invention may be admixed with other elastomers or elastomeric compounds before it is subjected to curing with sulphur.

The halobutyl elastomer(s), filler(s), dry liquid modifier(s) and optionally other filler(s) are mixed together, suitably at a temperature in the range of from 20 TO 200° C. A temperature in the range of from 50 to 150° C. is preferred. Normally the mixing time does not exceed one hour; a time in the range from 2 to 30 minutes is usually adequate. The mixing is suitably carried out on a two-roll mill mixer, which provides good dispersion of the filler within the elastomer. Mixing may also be carried out in a Banbury mixer, or in a Haake or Brabender miniature internal mixer. An extruder also provides good mixing, and has the further advantage that it permits shorter mixing times. It is also possible to carry out the mixing in two or more stages. Further, the mixing can be carried out in different apparatuses, for example one stage may be carried out in an internal mixer and another in an extruder.

According to the present invention the halobutyl elastomer(s), fillers(s) and dry liquid modifiers may be added incrementally to the mixing devise. Preferably, the halobutyl elastomer(s) and dry liquid modifier(s) are premixed and then the filler is added.

The enhanced interaction between the filler and the halobutyl elastomer results in improved properties for the filled elastomer. These improved properties include higher tensile strength, higher abrasion resistance, lower permeability and better dynamic properties. These render the filled elastomers suitable for a number of applications, including, but not limited to, use in tire treads and tire sidewalls, tire innerliners, tank linings, hoses, rollers, conveyor belts, curing bladders, gas masks, pharmaceutical enclosures and gaskets.

The filled halobutyl rubber compositions of the present invention, such as filled bromobutyl rubber compositions, find many uses, but mention is made particularly of use in tire tread compositions.

The invention is further illustrated in the following examples.

### EXAMPLES

Description of Tests:

Hardness and Stress Strain Properties were determined with the use of an A-2 type durometer following ASTM D-2240 requirements. The stress strain data was generated at 23° C. according to the requirements of ASTM D-412 Method A. Die C dumbbells cut from 2 mm thick tensile sheets (cured for tc90+5 minutes at 160° C.) were used. DIN abrasion resistance was determined according to test method DIN 53516. Sample buttons for DIN abrasion analysis were cured at 160° C. for tc90+10 minutes. The tc90 times were determined according to ASTM D-5289 with the use of a Moving Die Rheometer (MDR 2000E) using a frequency of oscillation of 1.7 Hz and a 10 arc at 170° C. for 30 minutes total run time. Dynamic testing (tan 6 at 0° C. and 60° C.) was carried out using the GABO. The GABO is a dynamic mechanical analyzer for characterizing the properties of vulcanized elastomeric materials. The dynamic mechanical properties provide an indication of traction with the best traction usually obtained with high values of tan δ at 0° C. Curing was achieved with the use of an Electric Press equipped with an Allan-Bradley Programmable Controller.

Description of Ingredients:

| Compound | Supplier |
|---|---|
| Bayer ® Bromobutyl ™ 2030 | Bayer Inc. |
| Taktene ™ 1203-G1 | Bayer AG |
| Hexamethyldisilazane | Aldrich |
| (HMDZ) | |
| HiSil 233 | PPG Industries |
| Dimethylethanolamine | Aldrich |
| (DMAE) | |
| Carbon Black, N 234 Vulcan 7 | Cabot Industries |
| Stearic Acid Emersol 132 NF | Acme Hardesty Co |
| Calsol 8240 | R. E. Carrol Inc. |
| Sunolite 160 Prills | Witco Corp. |
| Vulkanox ™ 4020 LG (6PPD) | Bayer AG |
| Vulkanox ™ HS/LG | Bayer AG |
| Sulfur (NBS) | NIST |
| Vulkacit ™ NZ/EG-C (CBS) | Bayer AG |
| Zinc Oxide | St. Lawrence Chemical Co. |

### Example 1

The following example describes the preparation of a silica-supported, DMAE dry liquid.

A wide mouth plastic jar was charged with 300 g of HiSil 233 and 135 g of DMAE (ca. 30 wt. % of DMAE). Several stainless steel ball bearings were then placed into the jar prior to sealing. The closed vessel was gently agitated for a period of 1 hour with the use of a bottle roller. The final dry liquid was then separated from the ball bearings and stored in a sealed vessel.

### Example 2

The following example describes the preparation of a carbon black-supported, DMAE/HMDZ dry liquid.

A wide mouth plastic jar was charged with 300 g of CB N234, 162.4 g of DMAE and 83.1 g of HMDZ (ca. 45 wt. % of DMAE/HMDZ). Several stainless steel ball bearings were then placed into the jar prior to sealing. The closed vessel was gently agitated for a period of 1 hour with the use of a bottle roller. The final dry liquid was then separated from the ball bearings and stored in a sealed vessel.

### Example 3

The following example describes the preparation of a silica-supported, DMAE/HMDZ dry liquid.

A wide mouth plastic jar was charged with 300 g of HiSil 233, 162.4 g of DMAE and 83.1 g of HMDZ (ca. 45 wt. % of DMAE/HMDZ). Several stainless steel ball bearings were then placed into the jar prior to sealing. The closed vessel was gently agitated for a period of 1 hour with the use of a bottle roller. The final dry liquid was then separated from the ball bearings and stored in a sealed vessel.

### Example 4—Comparative

The following example describes the preparation and analysis of a modifier-free (no dry liquid modifier) BIIR-Silica compound. This compound was prepared with the use of 6″×12″ inch two-roll mill according to the recipe given in Table 1. The roll temperature was allowed to stabilize at 30° C. at which point the rubber was introduced and allowed to band for 1 minute. The HiSil was then added incrementally over a period of 5 minutes. Once mixing was complete, the roll temperature was raised to 100° C. and the compound was allowed to band for an additional 10 minutes. The compound was then removed from the mill and allowed to cool to room temperature. The curatives were then added with the use of a 6×″12″ mill (roll temperature of 30° C.). The physical properties of cured articles derived from this formulation are given in Table 2.

### Example 5—Comparative

The following example describes the preparation and analysis of a standard silica tread formulation. The compound was prepared according to the recipe given in Table 1 and with the use of a 1.6 L Banbury (BR-82) internal mixer equipped with intermeshing rotors. The Mokon temperature was first allowed to stabilize at 30° C. With the rotor speed set at 77 rpm, the elastomers were introduced into the mixer. After 1 minute, ½ of the carbon black, silica and Si69 was added. The remaining half was added after 2 minutes. After 3 minutes of mixing, the Sundex and Sunolite were added. At 4 minutes, the stearic acid, Vulkanox and zinc oxide were added. The compound was allowed to mix for a total of 6 minutes at which point it was removed from the mixer. The curatives were then added on a RT, 10″×20″ two-roll mill. The physical properties of cured articles derived from this formulation are given in Table 2.

### Example 6

The following example describes the preparation and analysis of a BIIR-Silica compound which utilizes the dry liquid modifier described in Example 1. This compound was prepared with the use of 6″×12″ inch two-roll mill according to the recipe given in Table 1. The roll temperature was allowed to stabilize at 30° C. at which point the rubber was introduced and allowed to band for 1 minute. The HiSil and Example 1 were then added incrementally over a period of 5 minutes. Once mixing was complete, the roll temperature was raised to 100° C. and the compound was allowed to band for an additional 10 minutes. The compound was then removed from the mill and allowed to cool to room temperature. The curatives were then added with the use of a 6″×12″ mill (roll temperature of 30° C.). The physical properties of cured articles derived from this formulation are given in Table 2.

### Example 7

The following example describes the preparation and analysis of a BIIR-BR tread formulation which utilizes the dry liquid modifier described in Example 2. This compound was prepared with the use of 6″××12″ inch two-roll according to the recipe given in Table 1. The roll temperature was allowed to stabilize at 30° C. at which point the rubber was introduced and allowed to band for 0.5 minutes. At this point, the HiSil and Example 2 were added. After 2 minutes, the carbon black and stearic acid were introduced onto the mill. At 3.5 minutes, the Calsol, Sunolite and Vulkanox were added and mixing was allowed to proceed for a total of 6 minutes. At this point, the roll temperature was raised to 100° C. and the compound was allowed to band for an additional 10 minutes. The compound was then removed from the mill and allowed to cool to room temperature. The curatives were then added with the use of a 6″×12″ mill (roll temperature of 30° C.). The physical properties of cured articles derived from this formulation are given in Table 2.

### Example 8

The following example describes the preparation and analysis of a BIIR-BR tread formulation which utilizes the dry liquid modifier described in Example 3. This compound was prepared with the use of 6″××12″ inch two-roll mill according to the recipe given in Table 1. The roll temperature was allowed to stabilize at 30° C. at which point the rubber was introduced and allowed to band for 0.5 minutes. At this point, the HiSil and Example 3 were added. After 2 minutes, the carbon black and stearic acid were introduced onto the mill. At 3.5 minutes, the Calsol, Sunolite and Vulkanox were added and mixing was allowed to proceed for a total of 6 minutes. At this point, the roll temperature was raised to 100° C. and the compound was allowed to band for an additional 10 minutes. The compound was then removed from the mill and allowed to cool to room temperature. The curatives were then added with the use of a 6″×12″ mill (roll temperature of 30° C.). The physical properties of cured articles derived from this formulation are given in Table 2.

U.S. Pat. No. 6,706,804 describes the use of a mixture of a silazane compound and an additive which possesses at least one amine group and at least one hydroxyl group to obtain BIIR-silica compounds with desirable physical properties. Despite the advantages associated with this technology, the use of liquid modifiers represents an additional complication for the compounder with respect to handling and risk of exposure. The examples described above demonstrate that is possible to realize the levels of reinforcement described in U.S. Pat. No. 6,706,804 with the use of dry liquid forms of the above mentioned modifiers. Specifically, these modifiers are prepared at either 30 wt. % of 45 wt. % using either silica or carbon black as the carrier.

The white compound described in Example 6 exhibits superior levels of reinforcement and abrasion resistance when compared to the modifier-free control (Example 4). From these results it can be concluded that the use of the solid-supported modifier (as described in Example 1) significantly improves the level of polymer-filler interaction.

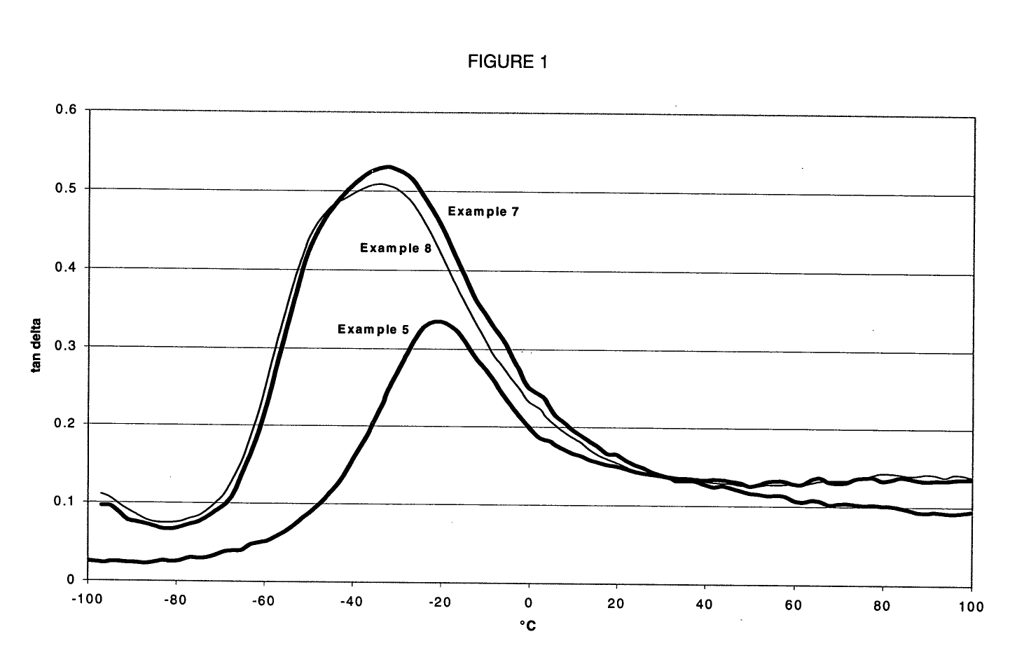

These dry-liquid modifiers are also applicable in the preparation of BIIR-BR tread formulations. Example 7 describes the preparation of a BIIR-BR tread formulation (based on a 50:50 mixture of BB2030 and Taktene 1203) which utilizes a mixed dry-liquid modifier supported on CB 234 (Example 2). Similarly, Example 8 describes the preparation of an analogous compounds with the use of a mixed dry-liquid modifier supported on HiSil 233 (Example 3). As can be seen from the data presented in Table 2 and the dynamic properties depicted in FIG. 1, it is possible to produce BIIR-based tread formulations which possess physical properties which are as good or better than the control compound (Example 5) and with superior dynamic properties. Specifically, the more pronounced mechanical glass transition and higher tan δ(0° C.) value seen for Examples 7 and 8 (c.f. Example 5) suggest that these formulations would possess significantly improved levels of wet-traction.

TABLE 1
Compound Formulations

| | PHR | | | | |
|---|---|---|---|---|---|
| Ingredient | Ex. 4 | Ex. 5 | Ex. 6 | Ex. 7 | Ex. 8 |
| BB2030 | 100 | | 100 | 50 | 50 |
| Buna VSL 5025-O | — | 70 | — | — | — |
| HM | | | | | |
| Taktene 1203 | — | 30 | — | 50 | 50 |
| HiSil 233 | 60 | 80 | 52.5 | 60 | 54.8 |
| CB 234 | — | — | — | 14.8 | 20 |
| Si69 | — | 6.4 | — | — | — |
| Ex. 1 | — | — | 10.7 | — | — |
| Ex. 2 | — | — | — | 9.4 | — |
| Ex. 3 | — | — | — | — | 9.4 |
| MgO | 1 | — | 1.0 | — | — |
| Calsol 8240 | — | — | — | 7.5 | 7.5 |
| Sundex 790 | — | 9.0 | — | — | — |
| Sunolite 160 Prills | — | 1.5 | — | 0.75 | 0.75 |
| Vulkanox 4020 LG | — | 1.0 | — | 0.5 | 0.5 |
| Vulkanox HS/LG | — | 1.0 | — | 0.5 | 0.5 |
| Vulkacit CZ/EG-C | — | 1.7 | — | 1.0 | 1.0 |
| Vulkacit D/C | — | 2.0 | — | — | — |
| Stearic Acid | 1.0 | 1.0 | 1.0 | 1.0 | 1.0 |
| Zinc Oxide | 1.5 | 2.5 | 1.5 | 2.0 | 2.0 |
| Sulfur | 0.5 | — | 0.5 | 1.0 | 1.0 |

TABLE 2
Compound Properties

| Physical Property | Ex. 4 | Ex. 5 | Ex. 6 | Ex. 7 | Ex. 8 |
|---|---|---|---|---|---|
| Shore A Hardness (pts.) | 67 | 80 | 73 | 60 | 62 |
| Ultimate Tensile (MPa) | 7.56 | 12.4 | 9.69 | 15.2 | 14.7 |
| Ultimate Elongation (%) | 715 | 212 | 467 | 565 | 538 |
| Stress @ 25% | 1.43 | 2.08 | 1.94 | 1.00 | 1.17 |
| Stress @ 50% | 1.36 | 2.96 | 1.91 | 1.31 | 1.52 |
| Stress @ 100% | 1.35 | 5.20 | 2.06 | 2.11 | 2.38 |
| Stress @ 200% | 1.75 | 11.55 | 3.27 | 4.42 | 4.59 |
| Stress @ 300% | 2.57 | — | 5.09 | 7.54 | 7.56 |
| DIN Abrasion Loss | 418 | 140 | 80 | 102 | 92 |
| (mm³) | | | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for preparing a filled halobutyl elastomer comprising admixing at least one halobutyl elastomer with at least one mineral filler, and at least dry liquid modifier.

2. The process according to claim 1, wherein the halobutyl elastomer is a brominated butyl elastomer or a chlorinated butyl elastomer.

3. The process according to claim 1, wherein the dry liquid modifier comprises a silazane compound and/or an additive which possesses at least one amine groups and at least one hydroxy group applied to a support.

4. The process according to claim 3, wherein the support is carbon black or silica.

5. The process according to claim 3, wherein the silazane compound is Hexamethyldisilazane (HDMZ), Heptamethyldisilazane, 1,1,3,3-Tetramethyldisilazane, 1,3-bis(Chloromethyl)tetramethyldisilazane, 1,3-Divinyl-1,1,3,3-tetramethyldisilazane, or 1,3-Diphenyltetramethyldisilazane.

6. The process according to claim 3, wherein the additive is monoethanolamine or N,N-dimethyamino-ethanol (DMAE).

7. The process according to claim 1, wherein the mineral filler is selected from the group consisting of regular or highly dispersible silica, silicates, clay, gypsum, alumina, titanium dioxide, talc and mixtures thereof.

8. The process according to claim 7, wherein the mineral filler is silica or clay.

9. The process according to claim 2, wherein the halogenated butyl elastomer is a brominated butyl elastomer.

10. The process according to claim 1, wherein the amount of the dry liquid modifier introduced is from 0.5 to 15 parts per hundred parts of elastomer.

11. The process according to claim 1, further comprising curing the elastomer.

12. A method of improving the tensile strength of a filled, cured elastomer composition comprising at least one halogenated butyl elastomer comprising admixing the halogenated butyl elastomer with at least one mineral filler and at least one dry liquid modifier and curing the elastomer composition.
